(19) United States
(12) Patent Application Publication
(10) Pub. No.: US 2025/0229606 A1
(43) Pub. Date: Jul. 17, 2025

(54) Air Vent for Ventilating an Interior of a Vehicle, and Vehicle

(71) Applicant: Mercedes-Benz Group AG, Stuttgart (DE)

(72) Inventors: Christoph MENZEL, Stuttgart (DE); Bernd PLOCHER, Rottenburg (DE); Daniel KEETMANN, Stuttgart (DE)

(21) Appl. No.: 18/727,982

(22) PCT Filed: May 23, 2023
(86) PCT No.: PCT/EP2023/063840

§ 371 Date: Jul. 10, 2024

(30) Foreign Application Priority Data
Jun. 28, 2022 (DE) 10 2022 002 328.8

(51) Int. Cl. B60H 1/34

(52) U.S. Cl. CPC B60H 1/3414; B60H 2001/3478

(57) ABSTRACT

The invention relates to an air vent (10) for ventilating an interior (12) of a vehicle, having a housing (14) that can be flowed through by air to ventilate the interior (12), having a flow body (20) that is arranged in the housing (14) and can be flowed around by the air, and having a guide vane (24) arranged upstream of the flow body (20) and able to be moved relative to the housing (14) and relative to the flow body (20), by means of which guide vane an outflow direction (26) in which the air flows out of the air vent (10) can be adjusted, wherein the flow body (20) can be moved translationally relative to the housing (14), whereby a flow cross-section (Q) of the air vent (10) that can be flowed through by the air and is arranged in the housing (14) can be adjusted.

### BACKGROUND AND SUMMARY OF THE INVENTION

The invention relates to an air vent for ventilating an interior of a vehicle, in particular of a motor car, and most particularly of a passenger car. The invention additionally relates to a vehicle preferably designed as a motor car, in particular as a passenger car, having at least one such air vent.

An outlet device for ventilating a vehicle interior by generating an outlet flow should be taken as known from DE 10 2015 017 009 A1. The outlet device has a housing having an inner surface that forms an exit portion and that extends in an axial direction between an air intake opening and an air exit opening that is located opposite the air intake opening. The inner surface is designed circumferentially symmetrically around a housing axis and has an axially circumferential portion and an end portion of the exit portion that forms the air exit opening.

EP 3 530 506 A1 discloses an air vent, having a housing with a portion that corresponds to the lateral surface of a cylinder and that has an air entry opening and an air exit opening. A passenger air vent for a motor vehicle is known from DE 10 2019 119 732 A1. DE 10 2019 131 554 A1 additionally discloses an air outlet device for discharging an airflow along an outlet direction into a passenger compartment of a vehicle.

The object of the present invention is to create an air vent and a vehicle having at least one such air vent, such that a particularly advantageous degree of adjustability of the air vent can be obtained in a particularly advantageous manner.

A first aspect of the invention relates to an air vent for ventilating an interior of a vehicle also described as a passenger cell or passenger compartment. This means that the vehicle preferably designed as a motor car, in particular as a passenger car, in its fully produced state has the air vent, which is preferably arranged in the interior. In particular, the interior is formed by a structure of the vehicle for example designed as a self-supporting body. Ventilating the interior should be understood to mean that air is fed to the interior, and thus the specified air is introduced into the interior. For this purpose, the air vent can be flowed through by the air. The air vent has a housing, also described as an outer housing, that can be flowed through by the specified air to ventilate the interior. This means that during an operation of the air vent, the air flows through the air vent and is introduced into the interior by means of the air vent, whereby the interior is ventilated. This means in particular that the air flowing through the air vent or the housing and flowing out of the air vent or the housing flows into the interior. For this purpose, the air vent for example has an exit opening, which can be flowed through by the air flowing through the housing and thus flowing through the air vent, wherein the air flowing through the exit opening and thus out of the air vent, in particular out of the housing, flows into the interior. In particular, the exit opening is an opening of the housing, such that for example the exit opening is delimited, in particular directly, by the housing. In particular, the exit opening is delimited completely continuously along its peripheral direction by the housing, in particular directly. It is in particular conceivable that the housing ends on the exit opening, in particular towards the interior.

The air vent has a flow body arranged in the housing, for example designed separately from the housing, which is also described as an inner body. The flow body can be flowed around by the air flowing through the housing, in particular on the external periphery. This means that the flow body has a lateral surface on the external periphery, which can be flowed around by the air flowing through the housing, in particular directly. For example, the lateral surface on the external periphery of the flow body is facing a lateral surface on the internal periphery of the housing, wherein for example an air conduit of the housing and thus of the air vent is delimited, in particular directly, by the lateral surface on the internal periphery of the housing, wherein the air conduit and thus the housing can be flowed through by the specified air to be fed to the interior.

The air vent additionally has a guide vane described as an actuator flap or damper that is arranged upstream of the flow body and can be moved relative to the housing and relative to the flow body. By means of the guide vane, in particular by moving the guide vane relative to the housing and preferably also relative to the flow body, an outflow direction in which the air flows out of the air vent and, in particular simultaneously, flows into the interior can be adjusted, i.e., can be changed or varied. The feature that the guide vane is arranged upstream of the flow body should be understood to mean that the air flowing through the housing, in particular the air conduit, first flows onto and around the guide vane and then flows around the flow body on its way through the housing, in particular through the air conduit, to the interior, in particular to the exit opening. Because the air flows onto and around the guide vane on its way through the housing to the interior, the air can for example be deflected, diverted or guided by means of the guide vane to thus adjust the outflow direction.

The specified exit opening of the air vent extends for example in a first plane, which is also described as an exit plane. For example, the housing has an intake opening, via which the air can be introduced into the housing, in particular into the air conduit. For example, the intake opening extends in a second plane, which is also described as an intake plane. It is conceivable that the first plane and the second plane are spaced apart from each other and run in parallel with each other.

To obtain a particularly advantageous degree of adjustability of the air vent in a particularly advantageous, in particular in a particularly weight-saving and cost-efficient manner, it is provided according to the invention that the flow body can be moved translationally relative to the housing, and preferably also relative to the guide vane, whereby a flow cross-section of the air vent that can be flowed through by the air and is arranged in the housing can be adjusted, i.e., can be changed or varied. In particular, the specified flow cross-section is the narrowest flow cross-section of the air vent that can be flowed through by the air on its way through the air vent. The feature that the flow cross-section can be adjusted by translationally moving the flow body relative to the housing and preferably also relative to the guide vane should be understood to mean that the flow cross-section can be optionally increased or reduced by translationally moving the flow body relative to the housing and preferably also relative to the guide vane. By adjusting the flow cross-section, a quantity of the air to be fed to the interior can for example be adjusted as required. A so-called throw distance or casting distance of the air can further be adjusted by adjusting the flow cross-section, for example. The throw distance or casting distance should be understood to mean a distance that the air flowing through the air vent, in particular starting from the air vent or starting from the exit opening, penetrates into the interior. Because it is now possible according to the invention to adjust the flow cross-section, and thus the quantity of the air to be fed to the interior and/or the throw distance of the air to be fed to the interior by means of the flow body, an additional adjusting or closing flap, in particular for closing the air vent can for example be dispensed with, such that the number of parts, and thus the weight and the cost of the air vent can be kept particularly low. The air vent, and thus for example the quantity of the air to be fed to the interior and/or the throw distance of the air to be fed to the interior can thus be adjusted in a space- and cost-efficient manner. Because the flow body can be moved translationally relative to the housing, the air vent, in particular its functionality, can be presented in a particularly visually advantageous manner, in particular, for example, because an end face of the flow body facing the interior can for example be perceived visually, in particular via the exit opening, in particular by vehicle occupants located in the interior.

For example, at least two different values of the flow cross-section can be adjusted by translationally moving the flow body relative to the housing. A first of the values is for example zero or greater than zero, wherein for example a second of the values is greater than the first value. When the second value is adjusted, a greater quantity of air flows into the interior and/or the throw distance is greater, for example, compared to when the first value of the flow cross-section is adjusted. By adjusting the first value, in particular if the first value is zero, the flow cross-section can for example be fluidically blocked, whereby the air vent cannot be flowed through by air, and thus it can be avoided that air or the specified air flows through the air vent into the interior. In particular, a flow speed of the air vent can be adjusted, i.e., varied, by adjusting the flow cross-section, wherein for example the air flows out of the air vent at the specified flow speed and flows into the interior, in particular flows through the exit opening. In particular, the throw distance can thus be adjusted, i.e., varied.

In an embodiment of the invention, to ventilate the interior, the housing can be flowed through by the air in a flow direction at least upstream of the guide vane. This means that the air flowing through the housing, in particular the air conduit, and thus the air vent, and to be fed to the interior has the specified flow direction at least upstream of the guide vane. This previously specified flow direction is also described as a first flow direction. Because, for example, the air is deflected, diverted or guided by means of the guide vane, for example in order thus to adjust the outflow direction also described as an exit direction, it is conceivable that the air has a second flow direction that is different from the first flow direction, in particular running obliquely or perpendicular to the first flow direction, downstream of the guide vane, such that for example the air flows through the housing, in particular the air conduit, downstream of the guide vane in the second flow direction. In particular, it is conceivable that the first flow direction runs perpendicular to the exit plane, and for example also perpendicular to the intake plane. In particular, the first flow direction coincides with an axial direction of the housing, and thus of the air vent as a whole. It is conceivable that the exit opening and/or the intake opening is round and is thus circular in shape, the central point of the circle for example lying on the axial direction of the housing, and thus of the air vent as a whole. In particular, the first flow direction is straight, and thus the first flow direction runs along a straight line, along which for example the specified central point lies. If the flow direction is mentioned in the following, this should be understood, unless otherwise specified, to mean the first flow direction.

So that the flow cross-section can be adjusted, i.e., varied, in a manner particularly suitable for requirements and in a particularly cost-efficient manner, it is provided in a further embodiment of the invention that the flow body can be moved back and forth translationally along the flow direction, and thus preferably in the axial direction of the housing and of the air vent as a whole, relative to the housing and preferably also relative to the guide vane, whereby the flow cross-section can be adjusted, i.e., varied.

A further embodiment is characterized in that the flow body is designed rotationally symmetrically on its external periphery at least over its predominant and thus over at least more than half of its length running along the flow direction, and thus in the axial direction of the air vent. This should in particular be understood to mean that the previously specified lateral surface of the flow body on the external periphery is designed rotationally symmetrically at least over the predominant length of the flow body running along the flow direction. The interior can thus be supplied with the air in a manner that is particularly favourable to flow.

So that a particularly advantageous degree of adjustability of the air vent can be obtained, it is provided in a further embodiment of the invention that the guide vane can be pivoted around a pivot axis running perpendicular to the flow direction relative to the housing and relative to the flow body in order thus to adjust the outflow direction. The feature that the pivot axis runs perpendicular to the flow direction should be understood to mean that the flow direction runs perpendicular to a flow plane, wherein the flow plane for example runs in parallel with the exit plane or coincides with the exit plane. The pivot axis runs perpendicular to a pivot axis plane, wherein the flow plane and the pivot axis plane run perpendicular to each other.

A further embodiment is characterized in that the guide vane can be rotated around an axis of rotation that coincides with the flow direction, and thus with the axial direction of the housing and of the air vent as a whole, relative to at least one housing part of the housing and relative to the flow body in order thus to adjust the outflow direction. A particularly extensive degree of adjustability of the air vent or of the outflow direction can thus be provided in a particularly cost-efficient manner.

So that the guide vane can be rotated around the axis of rotation in a manner particularly suitable for requirements and particularly easily, and thus so that the outflow direction can be adjusted as required, it is provided in a further embodiment of the invention that the housing has the at least one housing part as a first housing part, which is coupled with the guide vane. The housing additionally has a second housing part, which is for example arranged upstream or downstream of the first housing part. The first housing part, and with the first housing part the guide vane, can be rotated around the axis of rotation relative to the second housing part and relative to the flow body. In particular, the first housing part is for example designed as a ring, also described as a displacement ring or outer ring, via which the guide vane can be rotated particularly as required and advantageously around the axis of rotation, in particular via rotation of the ring relative to the second housing part.

To obtain a particularly extensive degree of adjustability of the air vent in a particularly cost-effective manner, a coupling device is provided in a further embodiment, by means of which the flow body and the guide vane are coupled with each other such that both the flow body and the guide vane can be moved relative to the housing by means of exactly one actuator that can in particular be operated electrically. In particular, the actuator can be a component of the air vent. Via the coupling device, the actuator can for example operate both the flow body and the guide vane, and thus for example shift the flow body translationally relative to the housing and move, in particular pivot and/or rotate, the guide vane relative to the housing. A particularly cost-effective structure of the air vent can thus be guaranteed.

Finally, it has proved particularly advantageous if the housing is designed rotationally symmetrically on the internal periphery at least in a longitudinal region of the housing, wherein the flow body is arranged in the longitudinal region. A feed of the air into the interior that is particularly favourable to flow can thus be provided.

The flow cross-section can for example be adjusted by translationally moving the flow body relative to the housing in the following manner: The flow body can for example be moved, and thus shifted, translationally relative to the housing between at least two positions that are different from each other. In a first of the positions of the flow body, for example, the first flow cross-section is adjusted, and in a second of the positions, for example, the second value of the flow cross-section is adjusted. For example, at least one first wall region of the flow body is arranged closer to a second wall region of the housing in the first position than in the second position, such that for example the flow cross-section or the value of the flow cross-section is lower in the first position than in the second position. In particular it is conceivable that in the first position, the first wall region abuts, in particular directly, on the second wall region, whereby for example the flow cross-section is adjusted to zero in the first position, and is thus closed. It is further conceivable that the wall regions delimit the flow cross-section directly at least in the second position. For example, it is conceivable that the second wall region tapers in the flow direction, for example, the first wall region also in particular tapers in the flow direction. The flow cross-section can thus be adjusted particularly advantageously.

A second aspect of the invention relates to a vehicle preferably designed as a motor car, in particular as a passenger car, which has at least one air vent according to the first aspect of the invention. Advantages and advantageous embodiments of the first aspect of the invention should be seen as advantages and advantageous embodiments of the second aspect of the invention and vice versa.

A further advantage of the invention is that as the guide vane is arranged upstream of the flow body, the guide vane cannot be visually seen, i.e., cannot be visually perceived, by vehicle occupants located in the interior. The adjustment of the outflow opening, also described as air deflection, can thus be implemented without any real parts being visible to people located in the interior, and specifically via the guide vane arranged upstream of the flow body, the guide vane being arranged behind the flow body in relation to a gaze direction in which a person located in the interior looks at the air vent and in particular the flow body, and thus not being visible to the person. The invention further enables a particularly advantageous integration of at least one or more additional functions into the flow body. For example, lighting can be integrated into the flow body. This means that at least one light source is arranged on, in particular in, the flow body, by means of which light can be provided, in particular while using electrical energy, the light for example in particular being able to be coupled into the interior via the exit opening, and thus for example being able to be visually perceived by a person located in the interior with their eyes. As an alternative or in addition, an air-freshener can be integrated into the flow body. For example, the flow body thus has at least one or several outflow openings, which can be flowed through by a fragrance that can for example be provided by a fragrance source. The air flowing around the flow body and flowing through the air vent can for example carry the fragrance that is flowing through the air vent along with it, and in particular transport it via the exit opening into the interior, whereby a particularly advantageous air freshening of the interior can be implemented.

Further advantages, features and details of the invention result from the following description of a preferred exemplary embodiment and with reference to the drawings. The features and combinations of features specified previously in the description and the features and combinations of features specified in the following description of the figures and/or shown in the figures alone can be used not only in the respectively specified combination, but also in other combinations or in isolation without leaving the scope of the invention.

### BRIEF DESCRIPTION OF THE DRAWINGS

FIG. 1 shows a schematic longitudinal sectional view of an air vent for ventilating an interior of a vehicle;

FIG. 2 shows a schematic front view of the air vent;

FIG. 3 shows a further schematic sectional view of the air vent;

FIG. 4 shows a further schematic sectional view of the air vent;

FIG. 5 shows a section of a schematic and perspectival aerial view of the air vent;

FIG. 6 shows a section of a schematic and perspectival longitudinal sectional view of the air vent;

FIG. 7 shows a section of a further schematic and perspectival longitudinal sectional view of the air vent;

FIG. 8 shows a section of a schematic and perspectival cross-sectional view of the air vent; and

FIG. 9 shows a section of a further schematic and perspectival cross-sectional view of the air vent.

### DETAILED DESCRIPTION OF THE DRAWINGS

Identical or functionally identical elements are provided with the same reference numerals in the figures.

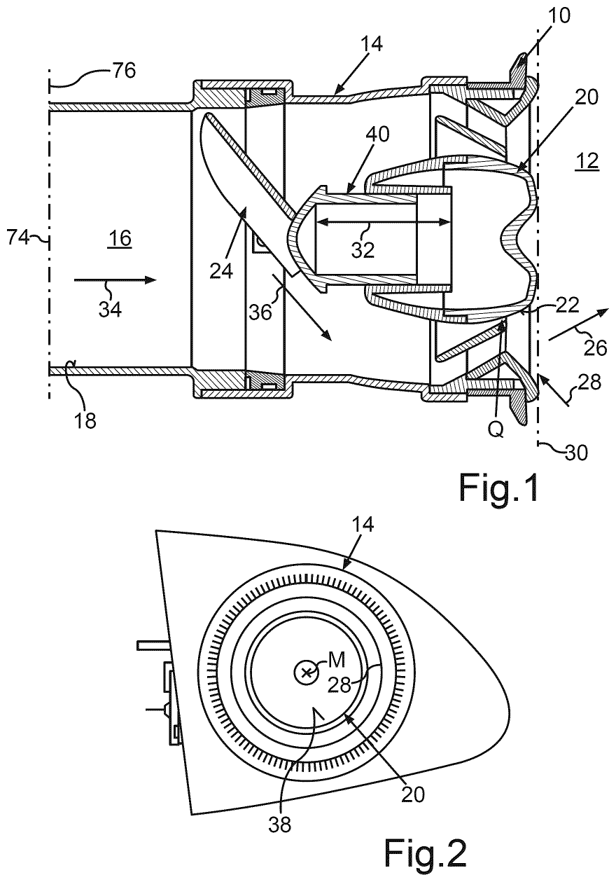

FIG. 1 shows, in a schematic longitudinal sectional view, an air vent 10 for ventilating an interior 12, also described as a passenger cell or passenger compartment, of a vehicle that is preferably designed as a motor car, in particular as a passenger car and has the air vent 10 in its completely produced state. The air vent 10 is also described as an air nozzle or ventilation nozzle, although the air vent 10 need not necessarily be designed as a nozzle in the actual technical sense. The air vent 10 has a housing 14 that can be flowed through by air, also described as interior air, to ventilate the interior 12. This means that the specified air flows through the housing 14 and thus the air vent 10 during an operation of the air vent 10, and in particular flows out of the air vent 10, and thus out of the housing 14 and, in particular simultaneously, flows into the interior 12. The air is thus fed to the interior 12, and thus introduced into the interior 12, whereby the interior 12 is ventilated.

The housing 14 has an air conduit 16 that can be flowed through by the air, which is for example delimited, in particular directly, by a lateral surface 18 on the internal periphery of the housing 14. The air vent 10 has a flow body 20 that is arranged in the housing 14 and can be flowed around by the air, in particular directly. In particular, the flow body 20 has a lateral surface 22 on the external periphery, which for example faces the lateral surface 18 on the internal periphery, in particular in the radial direction of the housing 14, and thus of the air vent 10 as a whole. During the specified operation, for example, the air flows through the air conduit 16 and thus through the housing 14, and the air flows around the lateral surface 22 on the external periphery, and thus the flow body 20, in particular directly. The flow body 20 is also described as an inner body.

The air vent 10 also has a guide vane 24 arranged in the housing 14, the guide vane being arranged upstream of the flow body 20. The housing 14, the guide vane 24 and the flow body 20 are preferably components that are designed separately from one another and that can for example be at least indirectly coupled with one another. In particular during the operation, the air flowing through the air conduit 16 and thus the housing 14 flows, in particular directly, onto the guide vane 24 also described as a damper or actuator flap, whereby for example the guide vane 24 deflects, diverts or guides the air flowing through the air conduit 16. The air flowing through the air conduit 16 can thus be deflected or diverted as required by means of the guide flap 24 via moving the guide flap 24 relative to the housing 14 and relative to the flow body 20, whereby an outflow direction in which the air flows out of the air vent 10 and flows into the interior 12 can be adjusted, i.e., varied. The outflow direction adjusted according to FIG. 1, in particular via the guide vane 24, is depicted in FIG. 1 by an arrow 26. It can be seen that the air vent 10 has an exit opening 28 that extends in an imaginary exit plane 30. The exit opening 28 is completely continuously and directly delimited along its peripheral direction by the housing 14, such that the exit opening 28 is an opening of the housing 14. The air conduit 16 leads into the interior 12 via the exit opening 28, such that during the operation, the air flows through the air conduit 16 and through the exit opening 28 and flows into the interior 12 via the exit opening 28, in particular along or in the outflow direction depicted by the arrow 26.

In the exemplary embodiment shown in the figures, the housing 14 and thus the air vent 10 also have an intake opening 74, via which the air can in particular be introduced into the air conduit and into the housing 14 in or along the first flow direction. For example, the intake opening 74 extends in an intake plane 76 that preferably runs in parallel with the exit plane 30 and is spaced apart from the exit plane 30.

To obtain a particularly advantageous degree of adjustability of the air vent 10 in a particularly advantageous manner, the flow body 20 can be moved translationally relative to the housing 14 and preferably also relative to the guide vane 24, which is depicted by a double arrow 32 in FIG. 1. This means that the flow body 20 can in particular be moved translationally back and forth along a straight line depicted by the double arrow 32, and thus along a movement direction running in a straight line relative to the housing 14 and preferably also relative to the guide vane 24, whereby a flow cross-section Q of the air vent 10 that can be flowed through by the air flowing through the air conduit 16 and is arranged in the housing 14 can be adjusted, i.e., changed or varied.

A first flow direction is depicted by an arrow 34 in FIG. 1, the air flowing through the air conduit 16 and thus the housing 14 flowing through the air conduit 16 and thus through the housing 14 in the flow direction, at least upstream of the guide vane 24. As the air flowing through the air conduit 16 flows, in particular directly, onto and around the guide vane 24, and can thus be diverted, deflected, re-directed or guided by means of the guide vane 24, in particular starting from the first flow direction, it is conceivable that the air flowing through the air conduit 16 flows through the air conduit 16 and thus the housing 14 in a second flow direction that is different from the first flow direction downstream of the guide vane 24, wherein for example the second flow direction runs obliquely or perpendicular to the first flow direction. In FIG. 1, the second flow direction is for example depicted by an arrow 36. As the guide vane 24 can be moved relative to the housing 14, the second flow direction can for example be adjusted and thus changed. It is conceivable to move the guide vane 24 relative to the housing 14 into a guide position in which for example the second flow direction corresponds to the first flow direction, and thus coincides with the first flow direction or runs in parallel with the first flow direction. Using the double arrow 32 and using the arrow 34, it can be seen that the flow body 20 can be moved translationally back and forth relative to the housing 14 along the first flow direction depicted by the arrow 34, whereby the flow cross-section Q can be adjusted. The straight movement direction depicted by the double arrow 32 thus coincides, for example, with the straight first flow direction depicted by the arrow 34. In the exemplary embodiment shown in the Figures, the movement direction and the first flow direction thus run in the axial direction of the housing 14, and thus of the air vent 10. In other words, the first flow direction and the movement direction coincide with the axial direction of the air vent 10 or of the housing 14. The axial direction of the housing 14 and thus of the air vent 10 as a whole runs perpendicular to the exit plane 30. For example, as can be seen from FIG. 2, the exit opening 28 is round, and thus designed in the shape of a circle, of which the central point M lies in the axial direction, and thus on a straight line that coincides with the axial direction. In particular, the movement direction (double arrow 32) and the first flow direction (arrow 34) also lie on the specified straight line.

As can be seen from FIG. 2, people located in the interior 12 can for example look at, and thus visually perceive, the flow body 20, and thus an end face 38 on the front of the flow body 20, with their eyes, in particular through the exit opening 28. As the flow body 20 can be moved translationally relative to the housing 14, the translational movement of the flow body 20 and thus of the adjustment of the flow cross-section Q can be presented in a particularly advantageous manner.

It can be particularly clearly seen from FIG. 1 that the flow body is designed at least over its predominant length running along the first flow direction and thus running in the axial direction of the air vent 10 such that it is rotationally symmetrical on its external periphery. In particular, the lateral surface 22 on the external periphery is designed at least over the predominant, and thus at least over more than half of the length, of the flow body 20 running in the axial direction of the air vent 10, such that it is rotationally symmetrical on its external periphery.

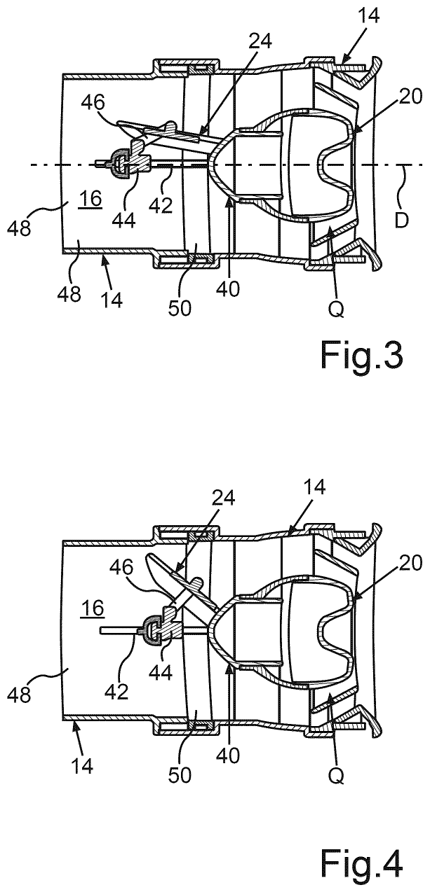

As can be seen from FIGS. 3 and 4, the guide vane 24 can be pivoted around a pivot axis running perpendicular to the flow direction and thus perpendicular to the axial direction of the air vent, and thus in particular in the radial direction of the air vent 10 relative to the housing 14 and also relative to the flow body 20 in order thus to adjust the outflow direction. For example, a base element 40 is arranged in the housing 14. It is in particular conceivable that the flow body 20 can in particular be translationally moved, and thus shifted, in particular along the movement direction relative to the base element 40, in order thus to adjust the flow cross-section Q. The base element 40 has a bearing region 42 presently designed as a pin or stud, which is presently designed cylindrically on the external periphery. A bearing sleeve 44 is shiftably arranged on the bearing region 42, the bearing sleeve thus being able to be shifted along the bearing region 42 and in particular along the movement direction relative to the housing 14. A lever 46 is coupled in a hinged manner with the bearing sleeve 44, also described as a shifting sleeve, and in a hinged manner with the guide vane 24. A connection point on or in which the lever 46 is coupled with the guide vane 24 in a hinged manner is spaced apart from the pivot axis. In particular, the guide vane 24 is mounted on the housing 14 or coupled with the housing 14 pivotably around the specified pivot axis relative to the housing 14. If the bearing sleeve 44 is shifted relative to the bearing region 42 and relative to the housing 14, in particular along the movement direction, the guide vane 24 is thus pivoted around the pivot axis relative to the housing 14 due to the hinged coupling of the lever 46 both with the bearing sleeve 44 and with the guide vane 24. FIG. 3 shows a first pivot position of the guide vane 24 and FIG. 4 shows a second pivot position of the guide vane 24, wherein the guide vane 24 can be pivoted and thus moved relative to the housing 14 by shifting the bearing sleeve 44 into the different pivot positions.

The guide vane 24 can furthermore be rotated around an axis of rotation D coinciding with the first flow direction and thus with the axial direction of the air vent 10 relative to at least one housing part 48 of the housing 14 and also relative to the flow body 20, and for example also relative to the base element 40, in order thus to adjust, and thus to vary the outflow direction. The housing 14 has the housing part 48 as a first housing part. The housing 48 is also a first housing part of the housing 14 and is also described as a first housing part. The housing 14 has a second housing part 50 that is presently designed as a ring and is also described as an outer ring. The housing part 50 is coupled with the guide vane 24 and can thus be rotated with the guide vane 24 around the axis of rotation D relative to the first housing part 48 and relative to the flow body 20 in order thus to adjust the outflow direction. In particular, the guide vane 24 is coupled with the housing part 50 pivotably around the specified pivot axis relative to the housing part 50, such that for example the pivot axis rotates with the housing part 50 around the axis of rotation D relative to the housing part 48. The guide vane 24 can thus be rotated around the axis of rotation D relative to the housing part 48 into at least two rotation positions that differ from each other in order thus to vary the outflow direction as required.

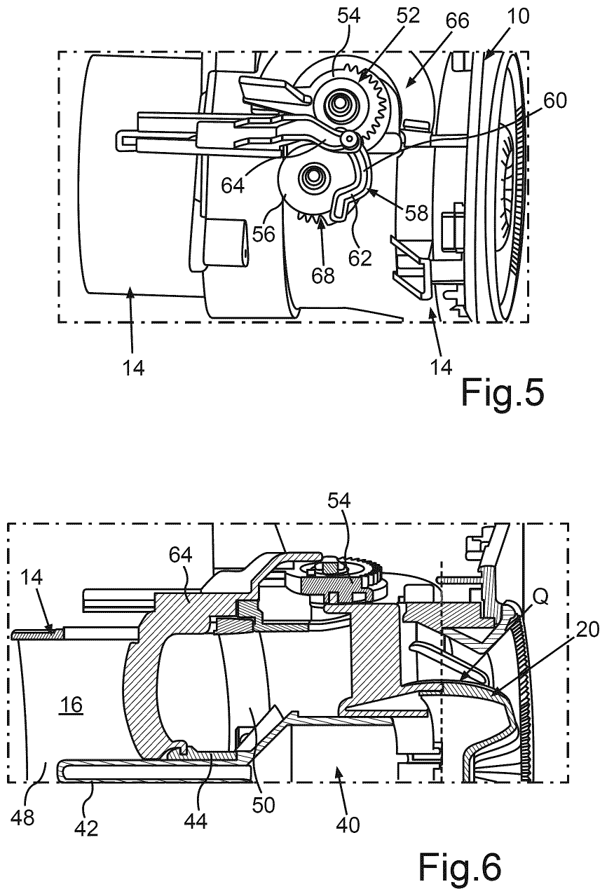

It can be seen from FIG. 5 that the air vent 10 has a coupling device 52, also described as kinematics, by means of which, as is explained in more detail in the following, the flow body 20 and the guide vane 24 are coupled with each other such that both the flow body 20 and the guide vane 24 can be moved relative to the housing 14 by means of exactly one actuator of the air vent 10 that can in particular be operated electrically. When viewed together with FIG. 6, it can be seen that the coupling device 52 has a first coupling element 54, which is presently designed as a first disc, in particular as a first rotating disc. The first rotating disc can be rotated around a first coupling element axis of rotation relative to the housing 14. In addition, the first coupling element 54 is coupled with the flow body 20 in a hinged manner such that if the first coupling element 54 is rotated around the first coupling element axis of rotation relative to the housing 14, the flow body 20 is thus shifted along the movement direction relative to the housing 14. If, for example, the first coupling element 54 is thus rotated around the first coupling element axis of rotation in a first rotation direction, the flow body 20 is thus shifted, and thus moved translationally, in a first direction relative to the housing 14, for example. If, for example, the first coupling element 54 is rotated around the first coupling element axis of rotation in a second rotation direction, opposite to the first rotation direction, relative to the housing 14, the flow body 20 is thus for example shifted in a second direction, opposite to the first direction, relative to the housing 14. For example, the directions coincide with the movement direction. For example, the flow cross-section Q is enlarged by the flow body 20 being moved in the first direction, for example the flow cross-section is reduced by the flow body 20 being shifted in the second direction.

The coupling device 52 additionally comprises a second coupling element 56 that is presently designed as a second rotating disc. The coupling element 56 can be rotated around a second coupling element axis of rotation relative to the housing 14, wherein for example the coupling element axes of rotation are spaced apart from each other and run in parallel with each other, or the coupling element axes of rotation run askew from each other.

It can be seen from FIG. 5 that the second coupling element 56 has a guide slot 58 having a first guide slot region 60 and a second guide slot region 62, wherein the guide slot regions 60 and 62 are connected to each other or transition into each other. A slider 64 engages in the guide slot 58, the slider in particular being able to be shifted along the movement direction relative to the housing 14. If the coupling element 58 is rotated around the second coupling element axis of rotation relative to the housing 14 while the slider 64 is (still) engaging in the first guide slot region 60, there is for example no shift of the slider 64 relative to the housing 14 in particular because, for example, the first guide slot region 60 has such a radius or lies or runs on such a circle, of which the central point lies on the second coupling element axis of rotation. If, however, the slider 64 comes into the second guide slot region 62 such that, for example, the second coupling element 56 is rotated around the second coupling element axis of rotation relative to the housing 14 while the slider 64 engages in the second guide slot region 62, the slider 64 is in particular shifted along the movement direction relative to the housing 14 by means of the second guide slot region 62. For this purpose, for example, the slider 64 or a partial region of the slider 64 engaging in the guide slot 58 glides along the wall regions of the second coupling element 56 delimiting the second guide slot region 62 such that the slider 64 is shifted, in particular in a movement direction relative to the housing 14, by the second coupling element 56 being rotated around the second coupling element axis of rotation relative to the housing 14.

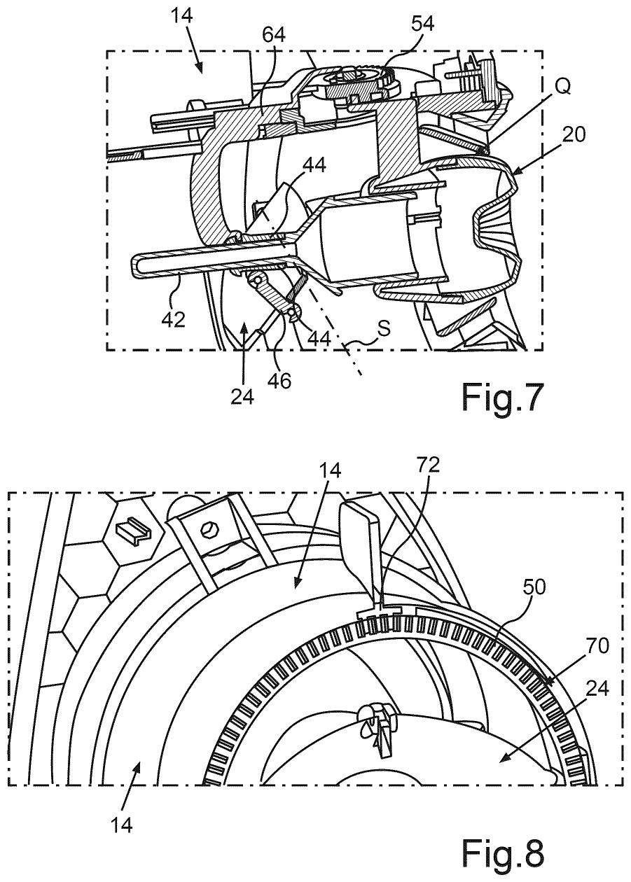

It can be seen from FIGS. 6 and 7 that the slider 64 is connected to the bearing sleeve 44, such that the bearing sleeve 44 can be shifted with the slider 64 in particular along the movement direction relative to the housing 14. If the slider 64 is thus shifted in particular along the movement direction relative to the housing 14, then the bearing sleeve 44 is thus shifted with the slider 64, such that the bearing sleeve 44 is shifted along the bearing region 42. The guide vane 24 is thus pivoted relative to the housing 14. If, for example, the slider 64, and with it the bearing sleeve 44, is shifted in the previously specified first direction relative to the housing 14 starting from the second pivot position of the guide vane 24 shown in FIG. 2, the guide vane 24 is thus for example pivoted from the second pivot position into the first pivot position shown in FIG. 3 relative to the housing 14. If, for example, the slider 64, and with it the bearing sleeve 44, is shifted in the second direction relative to the housing 14 starting from the first pivot position of the guide vane 24 shown in FIG. 3, the guide vane 24 is thus pivoted from the first pivot position shown in FIG. 3 into the second pivot position shown in FIG. 4 relative to the housing 14.

The coupling elements 54 and 56 are coupled with each other in particular in a torque-transmitting manner such that by rotating the coupling element 54 around the coupling element axis of rotation relative to the housing 14, the second coupling element 56 can be or is rotated around the second coupling element axis of rotation relative to the housing 14. For this purpose, the coupling elements 54 and 56 have toothings 66 and 68 that are designed as outer toothings and engage with each other, and are thus in engagement with each other. The previously specified actuator that can in particular be operated electrically is or can for example be coupled with the coupling element 54, such that the first coupling element 54 can be driven by means of the actuator and can thus be rotated around the first coupling element axis of rotation relative to the housing 14. If the coupling element 54 is rotated by means of the actuator around the first coupling element axis of rotation relative to the housing 14, then the coupling element 56 is driven by the coupling element 54, and is thus rotated around the second coupling element axis of rotation relative to the housing 14 due to the described coupling of the coupling element 54 with the coupling element 56. As long as the slider 64 only engages in the guide slot region 60 with regard to the guide slot regions 60 and 62, there is no pivoting of the guide vane 24 while the coupling elements 54 and 56 are rotated. If, for example, the actuator thus drives the coupling element 54 such that the coupling element 54, and thus the coupling element 56 are rotated, in particular simultaneously, such that the slider 64 only engages in the guide slot region 60 with regard to the guide slot regions 60, 62, then both of the coupling elements 54, 56 are otherwise rotated simultaneously, and the flow body 20 is shifted relative to the housing 14 by the rotation of the coupling element 54, but there is no pivoting of the guide vane 24. It is thus possible, for example, to shift the flow body 20, initially located in a first position, in the second direction, and thus into a second position, and thus to adjust the flow cross-section Q from a first value to a second value that is bigger than the first value, while there is no movement of the guide vane 24 relative to the housing 14. If the coupling elements 54, 56 are further rotated starting from the second position of the flow body 20 such that the slider 64 comes from the guide slot region 60 into the guide slot region 62 and is moved along the guide slot region 62, the guide vane 24 can thus be pivoted relative to the housing 14, in particular while there is no movement of the flow body 20 relative to the housing 14. If the coupling elements 54 and 56 are thus rotated relative to the housing 14, for example, while the slider 64 only engages in the guide slot region 62 with regard to the guide slot regions 60 and 62, then the guide vane 24 can be pivoted around the specified pivot axis relative to the housing 14 by means of the actuator, while there is no movement of the flow body 20 relative to the housing 14. It can in particular be seen that the respective toothing 66, 68 does not extend completely in the peripheral direction of the respective coupling element 54, 56 running around the respective coupling element axis of rotation, and instead only extends partially around the respective coupling element 54, 56.

The specified pivot axis around which the guide vane 24 can be pivoted relative to the housing 14 can be seen from FIG. 7, where it is labelled with S.

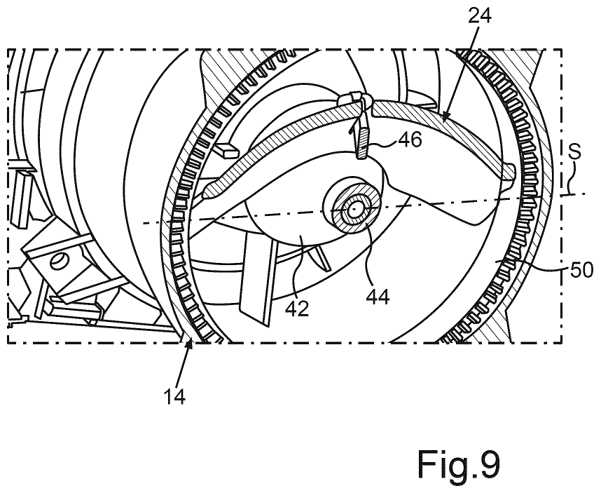

It can be seen from FIGS. 8 and 9 that the housing part 50 has a toothing 70 designed as an outer toothing and which is for example formed on an axial end face of the housing part 50, in particular in the manner of a toothing of a ring gear. A gearwheel 72 is also provided, which can be rotated around a gearwheel axis of rotation relative to the housing 14.

The gearwheel 72 has a gearwheel toothing corresponding with the toothing 70 in particular in the manner of a sprocket, the gearwheel toothing being in engagement with the corresponding toothing 70. The gearwheel axis of rotation runs perpendicular to the axis of rotation D. If the gearwheel 72 is rotated around the gearwheel axis of rotation relative to the housing 14, this rotation of the gearwheel 72 is transformed by means of the gearwheel toothing and the toothing 70 into a rotation of the housing part 50 around the axis of rotation D relative to the housing part 48. A second actuator is for example provided in addition to the previously specified actuator, the second actuator for example being able to be operated electrically. By means of the second actuator, the gearwheel 72 can be driven and thus rotated around the gearwheel axis of rotation relative to the housing 14, whereby the housing part 50 is driven by the gearwheel 72 and the axis of rotation D is rotated relative to the housing part 48. The guide vane 24 is thus rotated around the axis of rotation D relative to the housing part 48. It can thus be seen that the housing part 50, and with it the guide vane 24, can be rotated around the axis of rotation D relative to the housing part 48 without pivoting the guide vane 24 around the pivot axis S relative to the housing 14 and vice versa, such that the rotation of the guide vane 24 around the axis of rotation D and the pivot of the guide vane 24 around the pivot axis S can be implemented independently, in particular completely independently of each other. The outflow direction can thus be adjusted as particularly required. The coupling of the guide vane 24 with the housing part 50 can be particularly clearly seen from FIG. 9. The pivot axis S can also be seen.

1.-10. (canceled)

11. An air vent (10) for ventilating an interior (12) of a vehicle, comprising:
a housing (14) that is flowable through by air to ventilate the interior (12);
a flow body (20) that is disposed in the housing (14), wherein the air is flowable around the flow body (20); and
a guide vane (24) that is disposed upstream of the flow body (20) and that is movable relative to the housing (14) and relative to the flow body (20), wherein via the guide vane (24) an outflow direction (26) in which the air flows out of the air vent (10) is adjustable;
wherein the flow body (20) is movable translationally relative to the housing (14) such that a flow cross-section (Q) of the air vent (10) that is flowable through by the air and that is disposed in the housing (14) is adjustable;
wherein to ventilate the interior (12) the housing (14) is flowable through by the air in a flow direction (34) at least upstream of the guide vane (24);
wherein the flow body (20) is movable back and forth translationally along the flow direction (34) relative to the housing (14) such that the flow cross-section (Q) is adjustable;
wherein the flow body (20) is rotationally symmetrically on an external periphery of the flow body (20) at least over a predominant length of the flow body (20) running along the flow direction (16);
wherein the guide vane (24) is pivotable around a pivot axis(S) running perpendicular to the flow direction (16) such that the outflow direction (26) is adjustable;
wherein the guide vane (24) is rotatable around an axis of rotation (D), wherein the axis of rotation (D) coincides with the flow direction (16), relative to a first housing part (48) of the housing (14) and relative to the flow body (20) such that the outflow direction (26) is adjustable;
wherein the housing (14) has a second housing part (50) coupled with the guide vane (24) and wherein the second housing part (50) is rotatable with the guide vane (24) around the axis of rotation (D) relative to the first housing part (48) and relative to the flow body (20) such that the outflow direction (26) is adjustable.

12. The air vent (10) according to claim 11, further comprising a coupling device (52) via which the flow body (20) and the guide vane (24) are coupled with each other such that both the flow body (20) and the guide vane (24) are movable by exactly one actuator.

13. The air vent (10) according to claim 11, wherein the housing (14) is rotationally symmetrically on an internal periphery of the housing (14) at least in a longitudinal region of the housing (14) and wherein the flow body (20) is disposed in the longitudinal region.

14. A vehicle, comprising:
the air vent (10) according to claim 11.
